(19) United States
(12) Patent Application Publication
(10) Pub. No.: US 2013/0315417 A1
(43) Pub. Date: Nov. 28, 2013

(54) BLUETHOOTH-TO-RF TRANCEIVER

(71) Applicant: Cary Christie, Incline Village, NV (US)

(72) Inventor: Cary Christie, Incline Village, NV (US)

(21) Appl. No.: 13/864,523

(22) Filed: Apr. 17, 2013

Related U.S. Application Data
(60) Provisional application No. 61/625,431, filed on Apr. 17, 2012.

(51) Int. Cl. H04H 20/86

(52) U.S. Cl. CPC H04H 20/86
USPC 381/80

(57) ABSTRACT

A system for re-broadcasting a received media stream to multiple media players includes an input port for receiving the media stream, a processor for decoding the media stream into a format suitable for rebroadcast, and an output port for re-broadcasting the media stream to a plurality of media players.

### CROSS-REFERENCE TO RELATED APPLICATIONS

This application is a non-provisional of and claims priority to pending U.S. Provisional Patent Application Ser. No. 61/625,431, filed Apr. 17, 2012, the disclosure of which is hereby incorporated by reference in their entirety.

### TECHNICAL FIELD

Embodiments of the present invention relate generally to digital audio processing and, in particular, to broadcasting audio over a wired or wireless network connection.

### BACKGROUND

Bluetooth is a very popular and frequently used wireless protocol for sending digital signals between two devices. Many smartphones, laptops, tablets, and other such consumer electronic devices, for example, are capable of sending and receiving Bluetooth signals. Users of said devices may use Bluetooth to transmit audio and/or video media from their device to a media player (such as, for example, a Bluetooth-enabled loudspeaker or pair of headphones). One of the limitations of Bluetooth, however, is that it is incapable of transmitting to multiple receivers, so that an audio stream cannot be (for example) transmitted to a first loudspeaker in a first room and to a second loudspeaker in a second room. Other methods of broadcasting an audio and/or video stream from a consumer device (e.g., WiFi) may also be unsuitable because the high-latency nature of the broadcasting leads to unsynchronized audio and video, and also because broadcasting WiFi to multiple recipients may require the installation of additional software on the device (if it is even possible at all). A need therefore exists for a way to quickly and efficiently stream audio and/or visual data via a Bluetooth link to multiple recipients.

### SUMMARY

In general, various aspects of the systems and methods described herein receive a Bluetooth signal bearing audio and/or video data, convert the received data into an RF output, and broadcast the RF output to one or more devices for playback of the audio and/or video data,

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 illustrates a system for broadcasting media from a Bluetooth stream to multiple devices in accordance with an embodiment of the invention;

FIG. 2 illustrates a transceiver for broadcasting a received Bluetooth stream to multiple devices in accordance with an embodiment of the invention;

FIG. 3 illustrates an implementation of a receiver/transmitter in accordance with an embodiment of the invention; and

FIG. 4 illustrates an audiovisual system in accordance with an embodiment of the invention.

### DETAILED DESCRIPTION

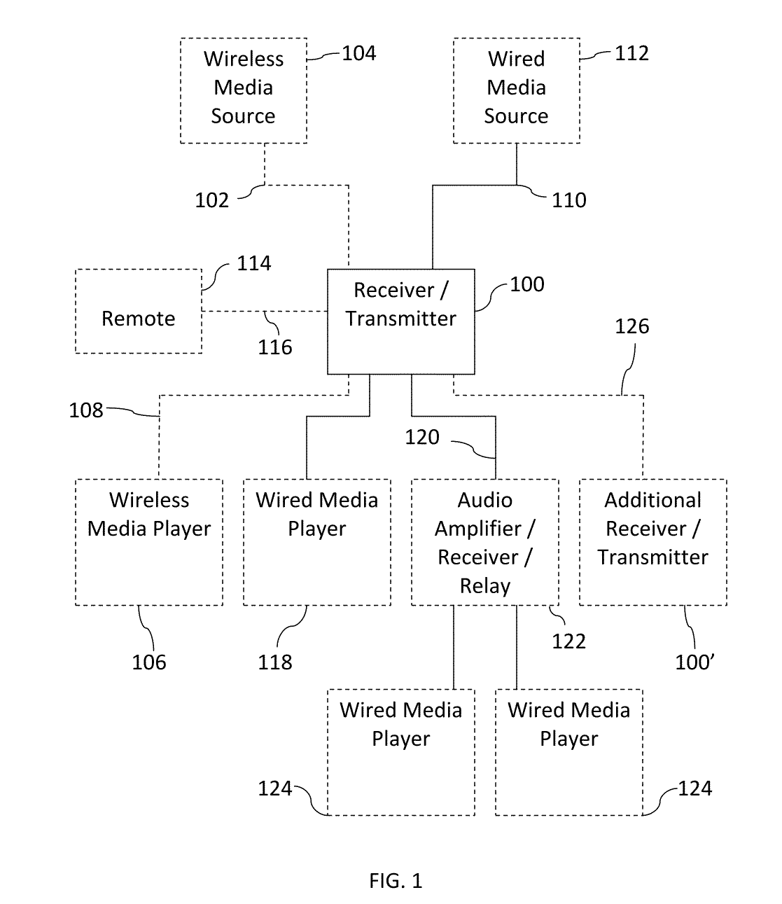

FIG. 1 illustrates a receiver/transmitter 100 that is configured to communicate via a Bluetooth link 102 with a wireless media source 104 (e.g., a smartphone, laptop, tablet, or other such device). The receiver/transmitter 100 may be a standalone device, such as a “wall wart,” desktop box, or other such device, or its functionality may be combined with another device or devices. The receiver/transmitter 100 may be included, for example, within a combination lighting fixture/sound system (such as the MUSICLITE offered by ARTISON and SYLVANIA), a soundbar, or some other speaker/electronics package. The wireless link 102 is described herein as a Bluetooth link, but the current invention is not limited to any particular protocol of wireless data transmission, and the link 102 may include any wireless data protocol as known in the art. The receiver/transmitter 100 receives audio and/or visual data over the wireless link 102 in the form of a digital or analog signal, processes (e.g., decodes) the data with minimal latency overhead, and re-transmits the audio and/or visual data (via another link or links 108) to one or more wireless media players 106 (e.g., one, two, three, four, or more media players 106) via a protocol that supports the broadcasting of data to multiple recipients. In various embodiments, the link 108 is an RF link or an infrared link. The media player 106 may be a loudspeaker, for example, that includes an RF receiver compatible with the link 108. The link 108 may vary for each media player 106 to enable (for example) differentiation between left, right, center, and rear speakers; in another embodiment the receiver/transmitter broadcasts a single, combined signal over the link 108, and each media layer 106 is configured to play back a different portion of the combined signal.

In various embodiments, the wireless re-broadcast link 108 operates using a frequency of 2.4 GHz, 5.8 GHz, 900 MHz, but any suitable frequency is within the scope of the current invention. If the same broadcast frequency is used for both the Bluetooth link 102 and the RF link 108, antenna replacement and/or hopping (i.e., automatic channel switching) may be used to prevent or reduced interference between the links 102, 108. In one embodiment, opposing-polarity antennas are used to minimize interference between the Bluetooth 102 and RF 108 links.

Alternatively or in addition, the receiver/transmitter 100 may receive a wired audio and/or video stream 110 from a wired media source 112 (e.g., a television, portable music player, or other such wired device). The wired media source 112 may also be a wireless device (e.g., a smartphone) configured as a wired device (by, e.g., connecting to the receiver/transmitter 100 via an audio cable). The wired link 110 may be any type of cable or protocol, include audio cables, HDMI cables, Ethernet cables, or any other type of wired connection; the current invention is not limited to any particular type of cable.

Either media source (the wireless 104 or the wired 112) may itself display or play back media content while also sending the same or different content via the links 102, 110 to the wireless media player 106 via the receiver/transmitter 100. For example, the wired media source 112 may be a television displaying video media locally (i.e., at the location of the media source 112) while sending audio data related to the video media to the receiver/transmitter 100. In another example, the wireless media source 104 may play music while sending a copy of the music to the receiver/transmitter 100. In each case, the receiver/transmitter 100 receives the incoming data, decodes/processes it, and re-broadcasts it via the link 108 with a low enough latency to be imperceptible, or nearly imperceptible, to human senses. For example, the delay between viewing video data playing back on the wired media source 112 and hearing its associated audio data via the wireless media player 108 (i.e., so-called “lip sync” delay) may be less than 100 ms, 50 ms, or 20 ms. Similarly, a delay between audio broadcast by one or more of the media sources 104, 112 and audio broadcast by the wireless media player 108 may be less than 100 ms, 50 ms, or 20 ms.

Control of the receiver/transmitter 100 (e.g., power on/off, input selection, output selection, volume level, digital-signal processing effects, or any other such control or feature) may come from one or more sources. In one embodiment, the wireless 104 or wired 112 media source is configured to run a software, firmware, and/or hardware application that may send and/or receive control signals over the links 102, 110. For example, control signals may be multiplexed with audio and/or video data flowing over the Bluetooth link 102; in another embodiment, control signals may be similarly multiplexed over the wired link 110 or may be sent over a dedicated signal wire included in the link 110. The control application may be a smartphone/tablet application downloaded using a commercially available market interface, for example, or a computer application downloaded from the Internet or a local network. In another embodiment, the receiver/transmitter 100 includes a web server, and the media sources 104, 112 may control the receiver/transmitter using a web browser. Alternatively or in addition, a remote control 114 may be used to communicate with the receiver/transmitter 100 via (for example) an infrared link 116.

The receiver/transmitter 100 may broadcast an output signal to different kinds of devices. As discussed above, one device may be the wireless media player 106. The receiver/transmitter 100 may alternatively or in addition send an output signal to a wired media player 118, which may be (for example) a wired loudspeaker. In one embodiment, receiver/transmitter 100 sends an output signal 120 to an audio amplifier/receiver/relay 122, which relays the output signal to an additional wired media player or players 124. In this embodiment, the output signal 120 (which may be a wired or wireless link) may be a bundle or group of several audio signals (e.g., five-channel surround-sound signals). The receiver 122 receives the bundled signals and drives the wired media players 124 appropriately.

In one embodiment, the receiver/transmitter 100 communicates with an additional receiver/transmitter 100′ via a peer-to-peer link 126. The additional receiver/transmitter 100′ may be positioned remotely to the first receiver/transmitter 100 (in, e.g., another room of a house). The first receiver/transmitter 100 may send audio and/or visual data, as well as control signals, over the link 126 to the additional receiver/transmitter 100′; the additional receiver/transmitter 100′ may thereafter broadcast an RF signal to additional media players not otherwise accessible to the first receiver/transmitter 100. The two receiver/transmitters 100, 100′ may coordinate the playback of shared media to account for any delay incurred by the link 126 (by, for example, delaying playback from the first receiver/transmitter 100 by a time equal to the latency of the link 126). Any number of additional receiver/transmitters may be added (in parallel with the additional receiver/transmitter 100′ or chained in series from the additional receiver/transmitter 100′).

The receiver/transmitter 100 may authenticate the wireless media source 104 before fully establishing the wireless link 102. For example, a user of the wireless media source 104 may press a button on the receiver/transmitter 100 to put its Bluetooth interface in “search mode” and/or confirm establishment of the link 102 by interacting with a menu, button, or dialog box on the wireless media source 104. In one embodiment, the link 102 may be established by physical contact (or close proximity) between the wireless media source 104 and the receiver/transmitter 100 (via, for example, an RFID chip in the wireless media source 104 and an RFID scanner in the receiver/transmitter 100). Such a system of authentication may be used, for example, in an environment having multiple receiver/transmitters 100 controlling separate audio/visual systems; a user of the wireless media source 104 may specify one particular receiver/transmitter 100 for interaction therewith. The unselected receiver/transmitters 100 thereafter ignore commands and media sent from the wireless media source 100. Furthermore, other users having Bluetooth-enabled devices are prevented from interacting with the selected receiver/transmitter 100 (either unintentionally or maliciously).

In one embodiment, a hotel, motel, bed-and-breakfast, or other similar provider of guest rooms provides a receiver/transmitter 100 in one or more of said rooms. A guest may use the receiver/transmitter 100 to play back audio data from a TV or music player also installed in the room via (for example) a provided remote control. The guest may also connect to the receiver/transmitter 100 using his or her own Bluetooth-enabled smartphone, tablet, laptop, or other such device. The receiver/transmitter 100 may broadcast an identification string to assist the guest in selecting the receiver/transmitter 100 disposed in the current room and not (for example) another receiver/transmitter 100 in an adjacent room. The guest may authenticate access with the receiver/transmitter 100 as described above. Once authenticated, the guest may use his or her personal device as a remote control to play back the provided media and/or stream personal media from his or her personal device. The receiver/transmitter 100 may log each successful and/or unsuccessful authentication attempt; the guest-room provider may charge the guest (either before or after authentication is completed) for access thereto. Any wireless media players in the room (e.g., the media player or players 106) may be configured with RF receivers that communicate only with the receiver/transmitter 100 disposed in the room and not (for example) a receiver/transmitter 100 in an adjacent room.

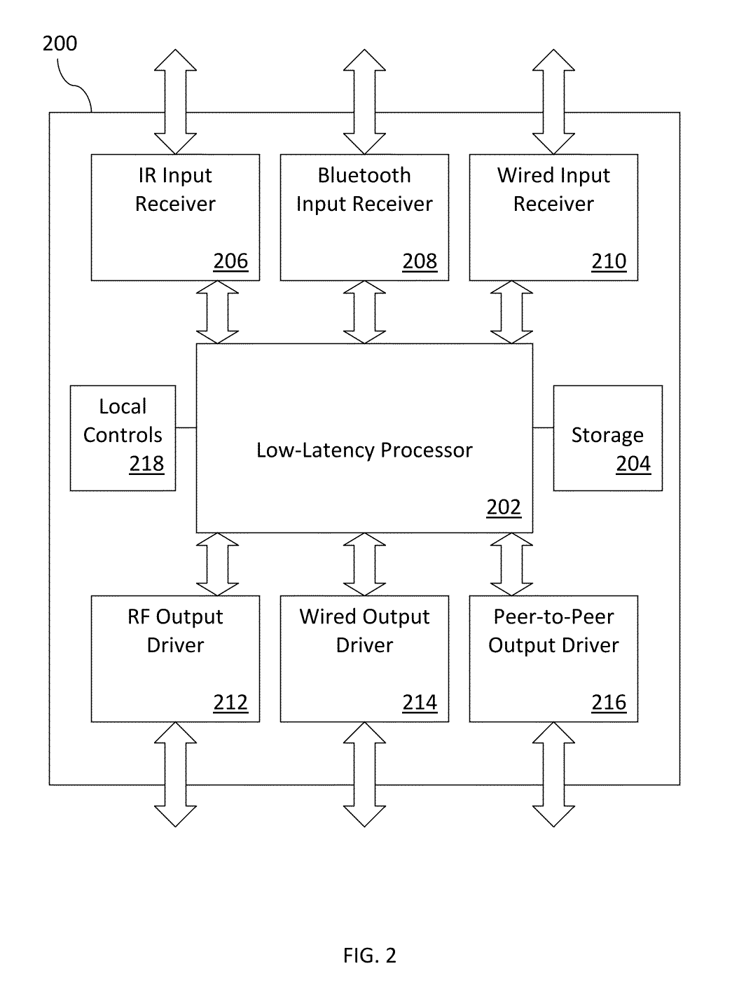

FIG. 2 illustrates one embodiment 200 of the receiver/transmitter 100. A low-latency processor 202 is used to decode/process/modify/etc. incoming streams of audio data and format them for re-broadcast in a different format. The processor 202 may be any digital, analog, or mixed-signal processor known in the art, such as a microprocessor, microcontroller, ASIC, digital-signal processor, or other similar devices. The system may also include volatile and/or non-volatile storage 204, such as RAM, SRAM, flash memory, firmware, a disk-based or solid-state hard drive, or any other medium. Input signals are received from an infrared receiver 206, a Bluetooth receiver 208, and/or a wired receiver 210. Each receiver 206, 208, 210 may include receiver electronics, antennas, ESD and surge protection circuitry, and/or other circuitry necessary to function, as one of skill in the art will understand. After processing by the processor 202, the received data (e.g., audio data) is re-broadcast using one or more output interfaces, such as an RF output driver 212, a wired output driver 214, and/or a peer-to-peer output driver 216 (which may broadcast either a wired or wireless output signal). The system 200 may also include local controls 218 for local access, such as a power switch, a reset button, and/or a Bluetooth “pairing” button or proximity interface. The system 200 may also be accessed via any of the input ports 206, 208, 210 for diagnostic, control, or debugging purposes.

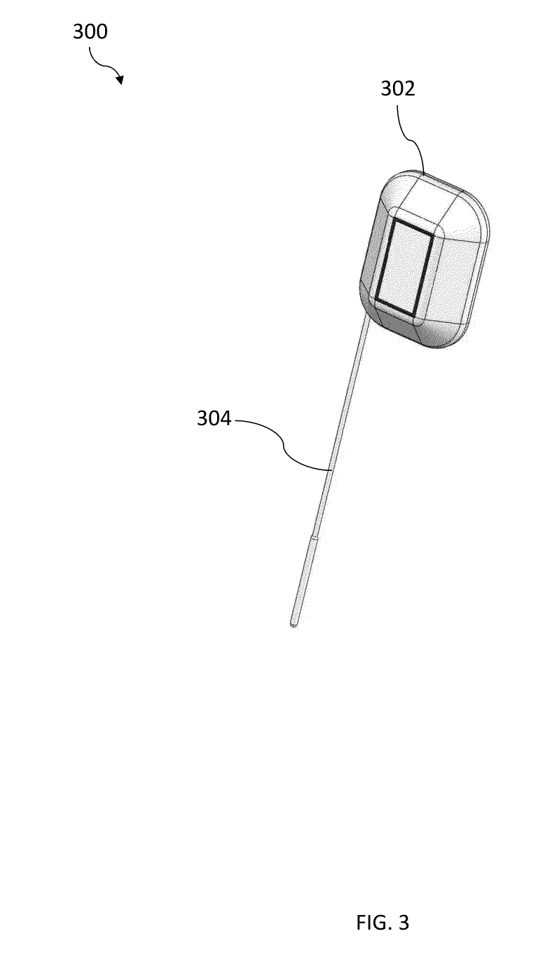

FIG. 3 illustrates an illustrative embodiment 300 of the receiver/transmitter. A main section 302 houses the electronics of the unit (e.g., the microprocessor, input ports, and output ports) and an antenna 304 is used to send and/or receive signals. The main section 302 may have an AC adapter (not shown) for plugging into a standard power outlet.

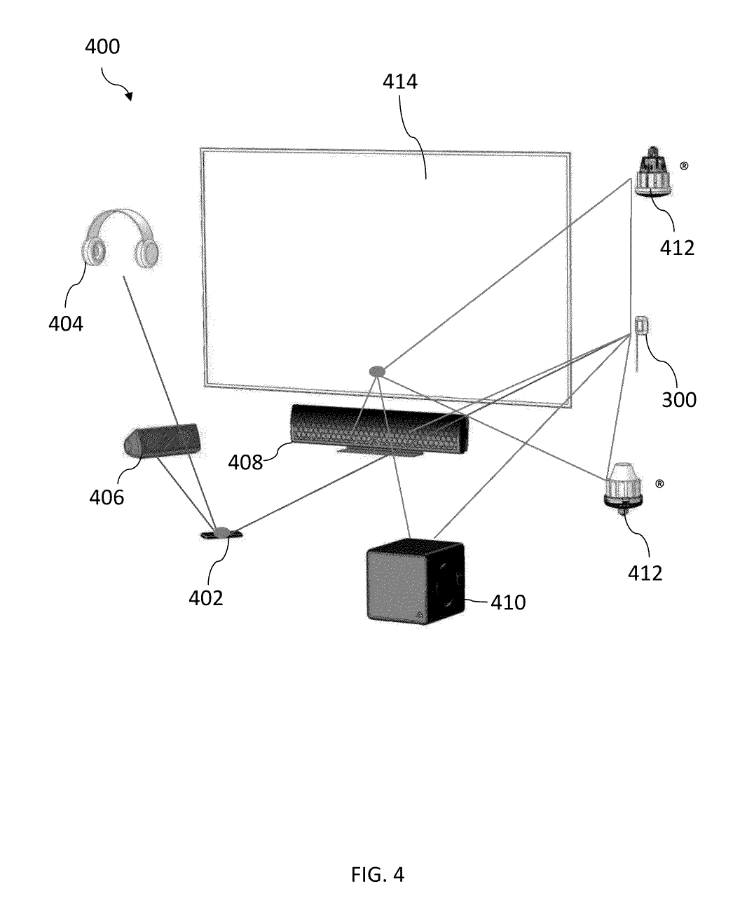

FIG. 4 illustrates an illustrative system 400 that uses the receiver/transmitter 300. A smartphone 402 provides a stream of audio data that may be sent to a pair of headphones 404, a loudspeaker 406, or to the receiver/transmitter 300. The receiver/transmitter 300 may re-broadcast the audio data to one or more media players, such as a sound bar 408, a subwoofer 410, and combination light/media-playing devices 412. A TV 414 may provide an additional stream of audio data to the receiver/transmitter 300, which may select between and/or mix the two incoming streams of audio data.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A system for re-broadcasting a received media stream to multiple media players, the system comprising:
an input port for receiving the media stream;
a processor for decoding the media stream into a format suitable for rebroadcast; and
an output port for re-broadcasting the media stream to a plurality of media players.

2. The system of claim 1, wherein the input port is a wireless input port and the media stream is received wirelessly.

3. The system of claim 1, wherein the output port is a wireless output port and the media stream is re-broadcast wirelessly.

4. The system of claim 1, wherein the media stream is re-broadcast to two, three, or four media players.

5. The system of claim 1, wherein a second media stream is received on the input port or on a second input port.

6. The system of claim 5, further comprising receiving, from a user device, commands related to the selection of the media stream or the second media stream.

7. The system of claim 1, further comprising receiving, from a user device, commands related to the playback of the media stream.

8. The system of claim 1, further comprising a local interface for authenticating a user.

9. The system of claim 1, wherein the input port is a Bluetooth port and the output port is an RF port.

10. The system of claim 1, wherein the latency of the system is less than 100 ms, 50 ms, or 20 ms.

11. The system of claim 1, wherein the system comprises a stand-alone device.

12. The system of claim 11, wherein the stand-alone device comprises a wall wart or desktop box.

13. The system of claim 1, wherein the system is incorporated into an electronics system.

14. The system of claim 13, wherein the electronics system comprises a MUSICLITE, soundbar, or other powered speakers.

15. A system for re-broadcasting a received media stream to multiple media players, the system comprising:
instructions for decoding a received media stream;
instructions for storing, in a computer memory, a decoded portion of the media stream; and
instructions for re-broadcasting the media stream.

16. A method for re-broadcasting a received media stream to multiple media players, the method comprising:
receiving a Bluetooth stream of data comprising audio data;
decoding and extracting the audio data from the Bluetooth stream of data; and
re-broadcasting the audio data to multiple recipients via an RF link.
